(19) United States
(12) Patent Application Publication
(10) Pub. No.: US 2021/0258817 A1
(43) Pub. Date: Aug. 19, 2021

(54) METHODS AND APPARATUSES FOR ENHANCED DATA PACKET FLOW HANDLING IN COMMUNICATIONS SYSTEMS

(71) Applicant: NOKIA TECHNOLOGIES OY, Espoo (FI)

(72) Inventors: Troels KOLDING, Klarup (DK); Guillermo POCOVI, Aalborg (DK); Claudio ROSA, Randers (DK); Istvan KOVACS, Aalborg (DK); Christian MARKWART, Munich (DE); Péter SZILÁGYI, Budapest (HU); Devaki CHANDRAMOULI, Plano, TX (US); Andreas WICH, Stuttgart (DE)

(21) Appl. No.: 17/252,550

(22) PCT Filed: Jun. 26, 2018
(86) PCT No.: PCT/US2018/039509

§ 371 Date: Dec. 15, 2020

(51) Int. Cl. H04W 28/02; H04W 28/06; H04L 29/06

(52) U.S. Cl. CPC H04W 28/0236; H04L 69/22; H04W 28/06; H04W 28/0268

(57) ABSTRACT

Systems, methods, apparatuses, and computer program products for improving redundant data treatment in communication systems are provided. One method may include detecting, by a network entity, that two or more flows of packets are related. The method may then include informing lower layer(s) that the packets are related along with their QoS constraints, and directing the lower layer(s) to ensure that latency, availability and/or reliability requirements of the packets are fulfilled.

### FIELD

Some example embodiments may generally relate to mobile or wireless telecommunication systems, such as Long Term Evolution (LTE) or fifth generation (5G) radio access technology or new radio (NR) access technology, or other communications systems. For example, certain embodiments may relate to data packet flow handling in such systems.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. Fifth generation (5G) or new radio (NR) wireless systems refer to the next generation (NG) of radio systems and network architecture. It is estimated that NR will provide bitrates on the order of 10-20 Gbit/s or higher, and will support at least enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. It is noted that, in 5G or NR, the nodes that can provide radio access functionality to a user equipment (i.e., similar to Node B in E-UTRAN or eNB in LTE) may be referred to as a next generation or 5G Node B (gNB).

### SUMMARY

One embodiment is directed to a method, which may include detecting, by a network entity, that two or more flows of packets are related, and informing at least one lower layer that the detected flows of packets are related and informing the at least one lower layer of quality of service (QoS) constraints of the packets. The method may also include directing the at least one lower layer to ensure that at least one of latency, availability, or reliability requirements of the flows of packets are fulfilled.

Another embodiment is directed to an apparatus including at least one processor and at least one memory comprising computer program code. The at least one memory and computer program code are configured, with the at least one processor, to cause the apparatus at least to detect that two or more flows of packets are related, inform at least one lower layer that the detected flows of packets are related and informing the at least one lower layer of quality of service (QoS) constraints of the packets, and direct the at least one lower layer to ensure that at least one of latency, availability, or reliability requirements of the flows of packets are fulfilled.

Another embodiment is directed to an apparatus that may include detecting means for detecting that two or more flows of packets are redundant, informing means for informing at least one lower layer that the detected flows of packets are redundant and informing the at least one lower layer of quality of service (QoS) constraints of the packets, and directing means for directing the at least one lower layer to ensure that at least one of latency, availability, or reliability requirements of the flows of packets are fulfilled.

Another embodiment is directed to an apparatus that includes circuitry configured to detect that two or more flows of packets are related, circuitry configured to inform at least one lower layer that the detected flows of packets are related and informing the at least one lower layer of quality of service (QoS) constraints of the packets, and circuitry configured to direct the at least one lower layer to ensure that at least one of latency, availability, or reliability requirements of the flows of packets are fulfilled.

Another embodiment is directed to a non-transitory computer readable medium comprising program instructions stored thereon for performing a process that includes detecting that two or more flows of packets are redundant, informing at least one lower layer that the detected flows of packets are redundant and informing the at least one lower layer of quality of service (QoS) constraints of the packets, and directing the at least one lower layer to ensure that at least one of latency, availability, or reliability requirements of the flows of packets are fulfilled.

### BRIEF DESCRIPTION OF THE DRAWINGS

For proper understanding of example embodiments, reference should be made to the accompanying drawings, wherein:

FIG. 1 illustrates an example user-plane architecture depicting the multi-device transceiver approach, according to some embodiments;

FIG. 2 illustrates an example of a user-plane system architecture, according to one embodiment;

FIG. 3 illustrates an example protocol stack for a multi-UE transceiver, according to certain embodiments;

FIG. 4a illustrates an example flow diagram of a method, according to an embodiment;

FIG. 4b illustrates an example flow diagram of a method, according to an embodiment;

FIG. 5a illustrates an example block diagram of an apparatus, according to an embodiment; and

FIG. 5b illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for improving data packet flow handling in communication systems, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

The use of protocols and standards that target increased reliability via redundant transmissions are gaining momentum. For instance, multi-path protocols such as multi-path transmission control protocol (MPTCP) and multi-path quick user datagram protocol internet connections (MPQUIC) allow creation of redundant data flows at transport layer to improve the reliability and latency performance of an end-to-end (E2E) connection. These protocols may also be utilized, in certain embodiments, to route successive packets through different interfaces or paths. This can reduce the number of successive packet errors, for example.

Similarly, data replication also plays an important role in the Time-Synchronized Networking (TSN) standards family (IEEE 802.1) as a way to achieve the stringent availability and reliability requirements of industrial applications. Frame replication (e.g., via IEEE 802.1CB) has been raised as something that would need further clarification in 3GPP. In some cases, such redundant transmissions will be terminated towards a single device (even if two ports on the same fifth generation system (5GS) are being addressed), while in other cases hardened industry devices may have two different radio modems (e.g., double UE device, similar to the approach of having two independent Ethernet cards in a server) that the replication or hybrid access service is tied to.

As will be discussed in further detail below, some example embodiments may be applicable to any external multi-path mechanism even when the multiple paths are not used in a redundant fashion (i.e., where each packet is duplicated on all paths). For example, certain embodiments may also be used for partly or fully disjoint data transmission. Indeed, some embodiments may allow a 3GPP system to know that two or more “streams” of replicated packets belong together.

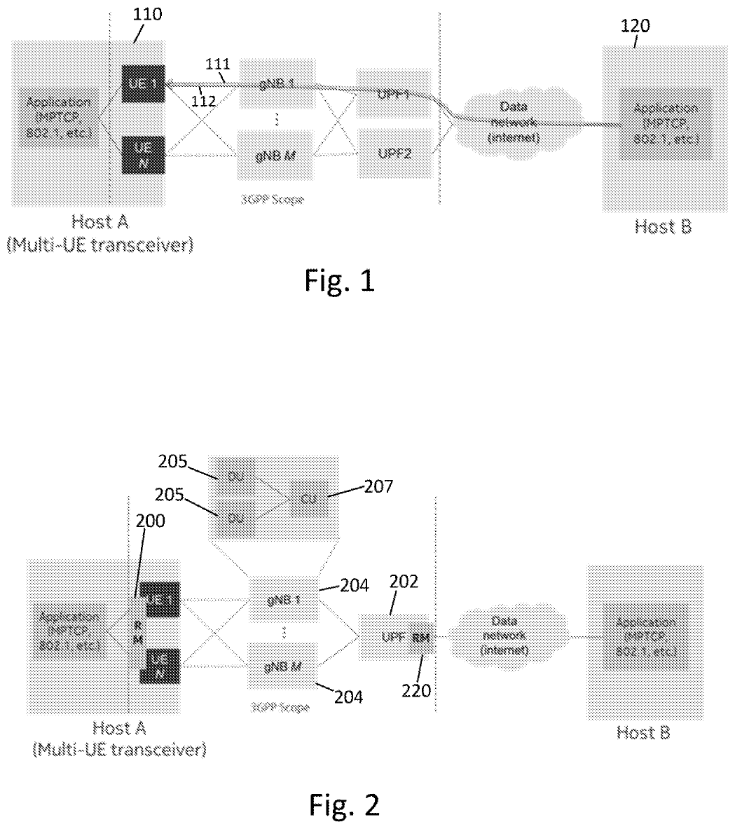

FIG. 1 illustrates an example user-plane architecture depicting the multi-device transceiver approach, according to some embodiments. In the example of FIG. 1, there are N UEs in a host 110, and two related downlink data streams 111, 112 (e.g., generated by a MPTCP or TSN host may be provided for possibly carrying data between host 110 and host 120.

5G New Radio (NR) is expected to carry at least the above-described types of traffic, which triggers several problem and challenges that may be addressed by certain embodiments described herein.

The duplication mechanism in MPTCP/MPQUIC and TSN protocols is often based on the expectation that the hardware of each sub-path is independent (for instance, a typical MPTCP use case is to transmit data on across both a wireless and a wireline connection). This is, however, not the case if the various replicas are transmitted over the same NR system, as illustrated in FIG. 1. In fact, in its current form, the NR standard is fully unaware of the packet replication occurring outside the 3GPP ecosystem, meaning that redundant packets will typically get the same treatment, e.g., transmitted on the same wireless link or even multiplexed within the same TTI, which jeopardizes reliability as both packets experience correlated performance. Similarly, for the case of industrial-grade multi-UE devices, the 5GS is also unaware that more multiple UEs may be contained within the same physical system and might also require uncorrelated treatment, e.g., be served by different gNBs and/or over different carrier frequencies.

One embodiment provides a replication manager (RM) framework that allows a 3GPP system to be aware, e.g., detect or have explicit information that two or more “streams” of replicated packets belong together. Based on that information, certain embodiments are able to then guide the lower layers to ensure that these packets receive optimized treatment in the 3GPP system, depending on whether the streams are terminated in a single UE or by two (or more) different UEs that belong together within the same hub-solution (e.g., TSN hub with two or more redundant 5G modems). As a result, 3GPP features can be used optimally to ensure that latency/availability/reliability requirements and expectations of external duplication methods are fulfilled (e.g., including hybrid access solutions, IEEE 802.1CB, etc.). Additionally, the RM framework may be applicable to any external multi-path mechanism even if the multiple paths are not used in a redundancy fashion (i.e., duplicating each packet on all paths) but for partly or fully disjoint data transmission.

Certain embodiments may provide an entity or functionality in the 3GPP system, which may be referred to as a replication manager (RM), that is configured to detect multiple related flows, and whether they are utilized for redundant packets of incoming IP/Ethernet flows at the transmitter side. In an embodiment, the replication manager may be configured to guide the lower layers to ensure their corresponding latency/availability/reliability requirements are fulfilled.

According to one embodiment, the RM may forward the received replica packets to the lower layers, for example by adding a header or other type of indication that indicates to the lower-layers to treat the packets as uncorrelated as possible. Further options may include the manipulation of the incoming data, for example by combining, excluding, or further replicating (among other operations) the incoming packets. For instance, in one embodiment, the RM may create three packets based on two incoming replica packets and make sure that they are scheduled by forwarding to the lower layers, as discussed above. In one embodiment, the RM may be configured to only forward a single or a subset of the packets to the lower layer but scaling appropriately the quality of service (QoS) constraint to be fulfilled by the lower layers.

In certain embodiments, at the receiver side, the receiver may translate and forward the internal streams to the corresponding external network(s). In order to make it transparent to the external network(s), further combine/remove/replicate operations may be applied to “reverse” the manipulation of the incoming data performed at the transmitter side. According to an embodiment, the RM entity at the receiver can use the header information (or share explicit information with the RM entity at the other end) to translate/re-build packets according to the external network(s) requirements. For example, for MPTCP redundant transmissions, one or more of the duplicated packets may be forwarded to the receiver host to ensure correct performance of the protocol, even if only a single packet was transmitted over the radio network.

For TSN applications, where the 5GS acts as a TSN ethernet bridge, the 5GS may need to forward a lower/equal/larger number of packets to the receiver host as specified in the IEEE 802.1CB standard.

FIG. 2 illustrates an example of a user-plane system architecture, according to one embodiment. In an embodiment, a RM entity 220 may be a part of the user plane function (UPF) 202 or attached to the UPF 202. In some embodiments, the control plane aspects of the RM entity may reside in a session management function (SMF). The example of FIG. 2 includes a multi-UE transceiver that may encompass various UEs (e.g., UE 1 to UE N) with independent hardware and protocol stacks. Each gNB 204 may also include multiple distributed units (DU) 205 attached to a central unit (CU) 207. In an example embodiment, a RM entity 200 may also be included in the multi-UE transceiver.

In the following, certain embodiments are discussed in connection with a downlink example where redundant data (e.g., generated by MPTCP or IEEE 802.1 standard) enters the 3GPP system and must be reliably received at the multi-UE receiver. Some embodiments may include one or more phases including, for example, discovery, reconfiguration, translation, and/or selection of replication manager and UPFs.

According to certain embodiments, the replication manager in the 3GPP system is aware that two or more “streams” of packets belong together. This can be achieved, for example, with an API or direct communication with an external management system (e.g., Hybrid Access Gateway (HAG) for MPTCP/MPQUIC protocols, or a Centralized Network Controller (CNC) in TSN systems). For example, in an embodiment, the replication manager may be aware or detect that two or more flows of packets are related by inspecting one or more of the packets or by receiving information directly from the external management system.

In an embodiment, data inspection may also be applied to some extent for autonomous discovery of multiple related flows. For instance, in MPTCP, redundant data can be detected in two steps: first by associating related sub-flows with each other; and second by looking at the data sequence number of the MPTCP data sequence signal (DSS) option to detect that two or more sub-flows are transmitting duplicate data (i.e., the sub-flows are operated in redundancy mode).

For the first step of associating related sub-flows, an embodiment may inspect the TCP synchronize (SYN) sub-flow establishment segments. In each MPTCP connection, the initial sub-flow carries the MP_CAPABLE option in the SYN segments, which announces a unique token for the connection. Any additional sub-flow established in the same MPTCP connection carries the MP_JOIN option in the SYN segments, with the same token as sent in the MP_CAPABLE option of the corresponding first sub-flow. The tokens thus identify the related sub-flows within a connection.

For the second step of detecting that sub-flows are transmitting duplicate data, an embodiment may monitor the sub-flow sequence numbers and the data sequence numbers of the packets in all sub-flows. The two types of sequence numbers may be available in the DSS options. Data duplication across sub-flows may be detected if the same relative data sequence numbers are observed in different sub-flows. The relative data sequence number may be generated for each packet by subtracting the sub-flow specific initial data sequence number from the packet's data sequence number. The initial data sequence number may be captured from the first packet in each sub-flow that carries a DSS option. The sequence numbers may be considered per UL and DL direction.

Some embodiments may also identify the corresponding QoS constraints that need to be fulfilled at this stage. This information may also be retrieved from the external management system, if available. Another option is to implicitly detect the QoS information based on the incoming data. For instance, if a single stream is known to require 99.9% reliability, the overall reliability of two or three streams of replicated data can be estimated to be e.g. 99.9999% or 99.9999999%, respectively. It is noted that the detection of packet duplication is also an indication that the MPTCP connection's intent is to improve reliability, which could be used to manipulate the QoS within the 5G system accordingly. In case packet duplication is not detected, different QoS targets may be derived (e.g., throughput maximization as the MPTCP connection tries to aggregate bandwidth over).

In an embodiment, the replication manager may inform the lower-layers (e.g., SDAP at the gNB/UE) of the detected redundant packets, as well as their QoS constraints. According to some embodiments, the replication manager may also manipulate the incoming data, e.g., merging two packets into a single packet but mapping it with a higher reliability constraint. The data manipulation may also be used as a way to fulfil the requirements of the external application—e.g. 3GPP-based TSN bridges might need to duplicate data if enforced by the TSN centralized network controller (CNC) or other configuration stemming from the TSN network.

In some embodiments, the additional information provided by the replication manager as part of UP packet header may be leveraged at lower layers (e.g., at the SDAP) to optimize the delivery of the information. The SDAP may be in charge of mapping higher-layer data to different data radio bearers (DRBs), and therefore it can enforce (or further guide the PDCP/MAC layers) the following data example treatments: ensure time diversity in the transmission of the replicated packets (within time budget), utilize frequency or antenna diversity including mapping the data to different component carriers, utilize spatial diversity in multi-connectivity-capable systems (transmission/reception different cells/DUs), apply further duplication for example at PDCP layer (PDCP duplication), and/or ensure handovers of data carrying paths do not happen simultaneously.

Systems with multi-UE capable receivers (e.g., as shown in the example of FIG. 1) open further possibilities for optimal delivery of the data. For instance, in some embodiments, the replication manager may guide the lower-layers to make sure that the redundant data is scheduled independently to each UE conforming the multi-UE receiver. In an embodiment, the replication manager may also ensure that the UEs are connected to different gNBs (this may not happen automatically by using standard cell selection criteria), and prevent simultaneous handovers on the different gNB-UE links.

For the example where the replication manager forwards a single packet with scaled QoS constraints, the packet may be treated in the usual way at the SDAP layer, e.g., exploiting the URLLC framework to deliver the single packet with 99.9999+% reliability. This might entail PDCP duplication, repetitions, or other techniques (e.g., non-duplication techniques) as decided by the radio system.

In an embodiment, each of the replicated packets may be mapped to separate DRBs in the SDAP layer, each DRB potentially using the URLLC framework (e.g., PDCP duplication) to increase the reliability of each path.

Once the data is at one or multiple UEs at the receiver side, and to maximize the benefits of example embodiments, the replication manager may be an entity that is common for all the UEs in the receiver. This facilitates collecting the multiple packet replicas in a single place, and potentially manipulate or re-assemble the packets to ensure transparency to the outside. The replication manager at the receiver may forward the received data to one or more output ports, as expected by the outside protocol.

According to certain embodiments, a UE may indicate support for the replication manager as part of a protocol data unit (PDU) session establishment request. This could be taken as an indication by the network/access management function (AMF) to select a session management function (SMF) that support selection of UPFs with the replication manager. Similarly, this indication can be taken into account by the SMF for selection of UPF with replication manager for the associated PDU sessions.

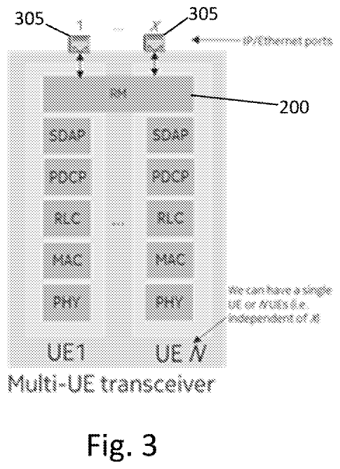

FIG. 3 illustrates an example protocol stack for a multi-UE transceiver, according to certain embodiments. As illustrated in FIG. 3, multiple data streams generated by the application may enter the system either in the form of IP flows, or Ethernet flows via a physical Ethernet port(s) 305. The latter case is especially relevant for the Ethernet-based 802.1 TSN standards. The incoming streams can be generated by the same applications or from different applications or hosts. The number of UEs within the transceiver may be transparent to the external application(s) and may also be independent of the number of physical Ethernet inputs if applicable. The RM entity 200, which can be deployed as a common entity for the N modems or as separate entities able to coordinate with each other, may decide how to perform the data split across the different UE modems. Similar to the previous example, the RM entity 200 may send all the data via a single UE (applying time diversity, etc.), duplicate the data to two or more UEs, etc.

The RM entity 200 at the multi-UE transceiver may communicate with the RM entity 220 at the network side. This facilitates correct packet translation towards the receiving host, e.g., knowing that two replica packets should be forwarded to the application even if only one is received from the lower layers. Besides, this entity may be responsible for announcing multi-UE capabilities to the SGS, for example: “UEx and UEy belong together and should be treated in a certain way.”

According to some embodiments, the deployment of the replication manager functions may include a set of central and distributed RM functions. While the central RM functions are deployed to the central network connection points (e.g., user-plane function (UPF) in 3GPP network), the distributed RM functions may be deployed to the decentral connection points (e.g., user-equipment function (UEF) in 3GPP network).

In an embodiment, each RM function may have at least one ingress interface where it receives information from one or multiple sources, detects if a received information is a replicated information based on a set of defined indicators, performs measures to discard the received information or to replicate the received information, and transmits the received information via at least one egress interface to one or multiple destinations.

According to certain embodiments, the defined indicator, which allows to detect, whether or not a received information is a replicated information may depend on the used protocols, but typically contains a list of message IDs (e.g., streamID in TSN) that may be used to transfer replicated information. Further, in one embodiment, the message IDs may be combined with additional network indicators (e.g., VLAN identifier) and a unique sequence number used by the end station(s) that initiates the information. In one embodiment, the RM entity 220 may be deployed as part of the UPF (or attached to the UPF). However, it is also possible to deploy it either closer to the radio (e.g. SDAP/PDCP layers) or outside the 3GPP system (e.g., as a network proxy).

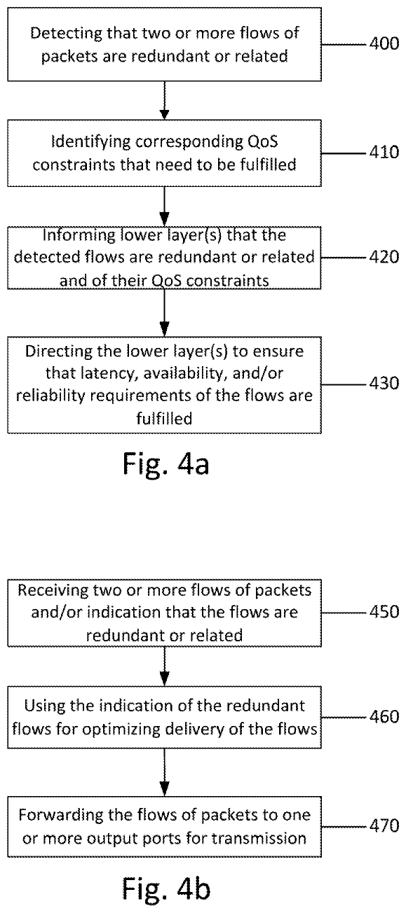

FIG. 4a illustrates an example flow diagram of a method for improving related or redundant data treatment in communication systems, according to one example embodiment. In certain example embodiments, the flow diagram of FIG. 4a may be performed by a network entity or network node in a 3GPP system, such as LTE or 5G NR. For instance, in some example embodiments, the method of FIG. 4a may be performed by a replication manager or replication management entity included in or attached to a UPF, as depicted in the example of FIG. 2.

In one embodiment, the method of FIG. 4a may include, at 400, detecting (or knowing/being aware) that two or more flows (or streams) of packets are related. According to some embodiments, the flows of packets may be related when the packets are redundant or when they belong together (e.g., are destined for the same application). For example, in an embodiment, the detecting 400 may include determining whether the flows of packets are used for redundant packets of IP/Ethernet flows. In some embodiments, the detecting 400 may include performing data inspection for autonomous discovery of the multiple related flows of packets.

In an example embodiment, for MPTCP, the detecting 400 may include associating related sub-flows with each other and/or inspecting the data sequence number of the MPTCP DSS option to detect that two sub-flows are transmitting duplicate data (i.e., the sub-flows are operated in redundancy mode).

According to one example, the associating of the related sub-flows with each other may include inspecting the TCP SYN sub-flow establishment segments. As discussed in detail above, tokens carried in the segments may be used to identify the related sub-flows within a connection.

In an embodiment, the inspecting of the data sequence number may include monitoring the sub-flow sequence numbers and the data sequence numbers of the packets in all sub-flows. Data duplication across sub-flows is detected if the same relative data sequence numbers are observed in different sub-flows. As mentioned above, the relative data sequence number may be generated for each packet by subtracting the sub-flow specific initial data sequence number from the packet's data sequence number. The initial data sequence number may be captured from the first packet in each sub-flow that carries a DSS option.

According to an embodiment, the method may also include, at 410, identifying corresponding QoS constraints that need to be fulfilled for the flows of packets. In one example, the identifying 410 may include retrieving the QoS constraints from an external management system, if available. In another example, the identifying 410 may include implicitly detecting the QoS constraints based on the incoming data flows. For instance, if a single flow is known to require 99.9% reliability, the identifying 410 may include estimating the overall reliability of two or three streams of replicated data to be, e.g., 99.9999% or 99.9999999%, respectively.

According to certain embodiments, the method may also include, at 420, informing lower layer(s), such as SDAP, that the detected flows of packets are related (or redundant) and, optionally, informing the lower layer(s) of the QoS constraints of the packets. In some embodiments, the method may include manipulating the incoming flows of packets, such as by merging two packets into a single packet but mapping it with a higher reliability constraint. This data manipulation can also be used to achieve the requirements of the external application, e.g., 3GPP-based TSN bridges may need to duplicate data if enforced by the TSN CNC.

In one embodiment, the method may further include, at 430, directing the lower layer(s) to ensure that the latency, availability, and/or reliability requirements (e.g., based on the QoS constraints) of the flows of packets are fulfilled. According to some embodiments, the directing 430 may include forwarding the detected flows of packets to the lower layer(s) with an added indication or header that indicates to the lower layer(s) to treat the packets as uncorrelated. In an example embodiment, the directing 430 may include manipulating the packets to ensure that the lower layer(s) treat the packets as uncorrelated. For example, the manipulating of the packets may include combining, excluding and/or further replicating the packets in a manner that indicates to the lower layer(s) to treat the packets as uncorrelated. According to one embodiment, the manipulating of the packets may include manipulating the header or control information within the packet to ensure that the lower layer(s) treat the packets as uncorrelated. In one example embodiment, the directing 430 may include forwarding only a subset of the packets to the lower layer(s) and scaling the QoS constraints to be fulfilled by the lower layer(s).

According to certain embodiments, for example where the system includes multi-UE capable receivers, the directing 430 may further include directing the lower layers to ensure that the related (or redundant) packets are scheduled independently to each UE of the multi-UE receiver and/or to ensure that the UE(s) are connected to different gNBs and/or to prevent simultaneous handovers on different gNB-UE links.

In an embodiment, the method may also include receiving an indication, from one or more UEs, of support for a replication management entity as part of a PDU establishment request. As one example, the method may then include using the indication received from the UE(s) in the selection of a UPF with a resource management entity for the associated PDU session(s).

FIG. 4b illustrates an example flow diagram of a method for improving related or redundant data treatment in communication systems, according to one example embodiment. In certain example embodiments, the flow diagram of FIG. 4b may be performed by a network entity or network node in a 3GPP system, such as LTE or 5G NR. For instance, in some example embodiments, the method of FIG. 4b may be performed by a SDAP layer at a UE or gNB, as depicted in the example of FIG. 3.

In one embodiment, the method of FIG. 4b may include, at 450, receiving two or more flows (or streams) of packets and/or an indication that the flows of packets are related. According to some embodiments, the flows of packets may be considered related when they are redundant or when they belong together. In an embodiment, the receiving 450 may also include receiving an indication of the QoS constraints of the packets. For example, in one embodiment, the receiving 450 may further include receiving, from a replication management entity, direction to ensure that the latency, availability, and/or reliability requirements (e.g., based on the QoS constraints) of the flows of packets are fulfilled. According to some embodiments, the receiving 450 may include receiving the related flows of packets with an added indication or header that indicates to treat the packets as uncorrelated. In an example embodiment, the packets may be manipulated to ensure that the packets are treated as uncorrelated. For example, the packets may be combined, excluded and/or further replicated in a manner that indicates to treat the packets as uncorrelated. In one example embodiment, the receiving 450 may include receiving only a subset of the packets to the lower layer(s) and scaled QoS constraints to be fulfilled for the packets.

In some embodiments, the method may also include, at 460, using the indication of the related flows of packets for optimizing delivery of the flows of packets. According to certain embodiments, the optimizing of the delivery of the flows may include one or more of: ensuring time diversity in the transmission of the replicated packets (within time budget), utilizing frequency or antenna diversity including mapping the data to different component carriers, utilizing spatial diversity in multi-connectivity-capable systems (transmission/reception different cells/DUs), applying further duplication (e.g., PDCP layer duplication), and/or ensuring handovers of data carrying paths do not happen simultaneously.

According to certain embodiments, for example in systems with multi-UE capable receivers, the optimizing of the delivery of the flows may include one or more of: scheduling the related packets independently to each UE comprising the multi-UE receiver, connecting the UEs to different gNBs, and/or preventing simultaneous handovers on the different gNB-UE links.

In an example where a single packet with scaled QoS constraints is received, the method may include treating the packet in a normal manner at the SDAP layer. For example, the URLLC framework may be exploited to deliver the single packet with 99.9999+% reliability. This may include PDCP duplication, repetitions, or other techniques as decided by the communication system. In another example, the method may include mapping each of the redundant flows of packets to separate DRBs in the SDAP layer, each DRB potentially using the URLLC framework (e.g., PDCP duplication) to increase the reliability of each path.

According to some embodiments, the method may further include, at 470, forwarding the flows of packets to one or more output ports for transmission to one or multiple destinations.

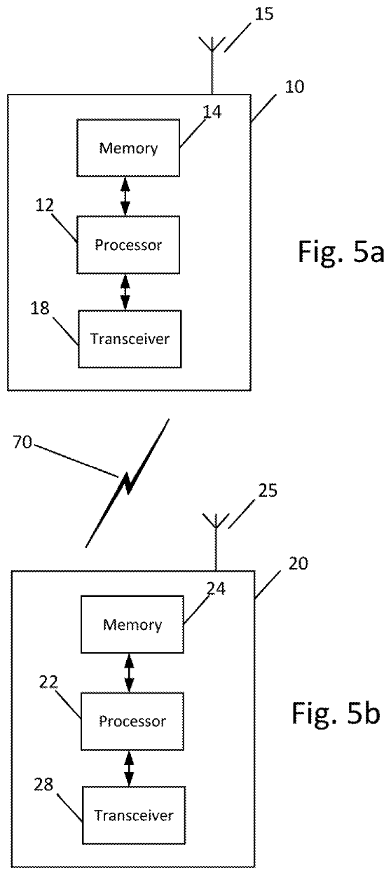

FIG. 5a illustrates an example of an apparatus 10 according to an embodiment. In an embodiment, apparatus 10 may be a node, host, or server in a communications network or serving such a network. For example, apparatus 10 may be a base station, a Node B, an evolved Node B (eNB), 5G Node B or access point, next generation Node B (NG-NB or gNB), CU of a gNB, WLAN access point, serving gateway (SGW), and/or mobility management entity (MME) associated with a radio access network, such as a GSM network, LTE network, 5G or NR. In one embodiment described herein, apparatus 10 may be a replication manager or replication management entity included in or attached to a UPF.

It should be understood that, in some example embodiments, apparatus 10 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 5a.

As illustrated in the example of FIG. 5a, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 12 is shown in FIG. 5a, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15. The radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device).

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiving circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to case an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, CU of a gNB, SGW, or the like. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as the flow diagram illustrated in FIG. 4a. For instance, in some examples, apparatus 10 may correspond to or represent a RM in or associated with a UPF. In certain embodiments, apparatus 10 may be configured to perform a procedure for improving related or redundant data treatment in a system.

In one embodiment, apparatus 10 may be controlled by memory 14 and processor 12 to detect (or be aware) that two or more flows (or streams) of packets are related. According to some embodiments, apparatus 10 may detect that two or more flows of packets are related if the packets are redundant or if the packets belong together. For example, in an embodiment, apparatus 10 may be controlled by memory 14 and processor 12 to determine whether the flows of packets are used for redundant packets of IP/Ethernet flows. In some embodiments, apparatus 10 may be controlled by memory 14 and processor 12 to perform data inspection for autonomous discovery of the multiple related flows of packets.

In an example embodiment, for MPTCP, apparatus 10 may be controlled by memory 14 and processor 12 to associate related sub-flows with each other and inspecting the data sequence number of the MPTCP DSS option to detect that two sub-flows are transmitting duplicate data (i.e., the sub-flows are operated in redundancy mode).

According to one example, apparatus 10 may be controlled by memory 14 and processor 12 to inspect the TCP SYN sub-flow establishment segments, in which tokens carried in the segments may be used to identify the related sub-flows within a connection.

In an embodiment, apparatus 10 may be controlled by memory 14 and processor 12 to monitor the sub-flow sequence numbers and the data sequence numbers of the packets in all sub-flows. Data duplication across sub-flows is detected if the same relative data sequence numbers are observed in different sub-flows. As mentioned above, the relative data sequence number may be generated for each packet by subtracting the sub-flow specific initial data sequence number from the packet's data sequence number. The initial data sequence number may be captured from the first packet in each sub-flow that carries a DSS option.

According to an embodiment, apparatus 10 may be further controlled by memory 14 and processor 12 to identify corresponding QoS constraints that need to be fulfilled for the flows of packets. In one example, apparatus 10 may be controlled by memory 14 and processor 12 to retrieve the QoS constraints from an external management system, if available. In another example, apparatus 10 may be controlled by memory 14 and processor 12 to implicitly detect the QoS constraints based on the incoming data flows. For instance, if a single flow is known to require 99.9% reliability, apparatus 10 may be controlled by memory 14 and processor 12 to estimate the overall reliability of two or three streams of replicated data to be, e.g., 99.9999% or 99.9999999%, respectively.

According to certain embodiments, apparatus 10 may also be controlled by memory 14 and processor 12 to inform lower layer(s), such as SDAP, that the detected flows of packets are related (or redundant) and, optionally, to inform the lower layer(s) of the QoS constraints of the packets. In some embodiments, apparatus 10 may be controlled by memory 14 and processor 12 to manipulate the incoming flows of packets, such as by merging two packets into a single packet but mapping it with a higher reliability constraint. This data manipulation can also be used to achieve the requirements of the external application, e.g., 3GPP-based TSN bridges may need to duplicate data if enforced by the TSN CNC.

In one embodiment, apparatus 10 may be further controlled by memory 14 and processor 12 to direct the lower layer(s) to ensure that the latency, availability, and/or reliability requirements (e.g., based on the QoS constraints) of the flows of packets are fulfilled. According to some embodiments, apparatus 10 may be controlled by memory 14 and processor 12 to forward the detected flows of packets to the lower layer(s) with an added indication or header that indicates to the lower layer(s) to treat the packets as uncorrelated. In an example embodiment, apparatus 10 may be controlled by memory 14 and processor 12 to manipulate the packets to ensure that the lower layer(s) treat the packets as uncorrelated. For example, apparatus 10 may be controlled by memory 14 and processor 12 to combine, exclude and/or further replicate the packets in a manner that indicates to the lower layer(s) to treat the packets as uncorrelated. In one example embodiment, apparatus 10 may be controlled by memory 14 and processor 12 to forward only a subset of the packets to the lower layer(s) and scaling the QoS constraints to be fulfilled by the lower layer(s).

According to certain embodiments, for example where the system includes multi-UE capable receivers, apparatus 10 may be controlled by memory 14 and processor 12 to direct the lower layers to ensure that the related packets are scheduled independently to each UE of the multi-UE receiver and/or to ensure that the UE(s) are connected to different gNBs and/or to prevent simultaneous handovers on different gNB-UE links.

In an embodiment, apparatus 10 may be controlled by memory 14 and processor 12 to receive an indication, from one or more UEs, of support for a replication management entity as part of a PDU establishment request. As one example, apparatus 10 may then be controlled by memory 14 and processor 12 to use the indication received from the UE(s) in the selection of a UPF with a resource management entity for the associated PDU session(s).

FIG. 5b illustrates an example of an apparatus 20 according to another example embodiment. In example embodiments, apparatus 20 may be a node or server associated with a radio access network, such as a LTE network, 5G or NR or other radio systems which might benefit from an equivalent procedure. In certain embodiments, examples of apparatus 20 may include an SDAP entity or RM at a UE or gNB.

In some example embodiments, apparatus 20 may include one or more processors, one or more computer-readable storage medium (for example, memory, storage, or the like), one or more radio access components (for example, a modem, a transceiver, or the like), and/or a user interface. In some example embodiments, apparatus 20 may be configured to operate using one or more radio access technologies, such as GSM, LTE, LTE-A, NR, 5G, WLAN, WiFi, NB-IoT, MulteFire, and/or any other radio access technologies. It should be noted that one of ordinary skill in the art would understand that apparatus 20 may include components or features not shown in FIG. 5b.

As illustrated in the example of FIG. 5b, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 5b, multiple processors may be utilized according to other example embodiments. For example, it should be understood that, in certain example embodiments, apparatus 20 may include two or more processors that may form a multiprocessor system (e.g., in this case processor 22 may represent a multiprocessor) that may support multiprocessing. In certain example embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an example embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In example embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, BT-LE, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, in one example embodiment, transceiver 28 may be configured to modulate information on to a carrier waveform for transmission by the antenna(s) 25 and demodulate information received via the antenna(s) 25 for further processing by other elements of apparatus 20. In other example embodiments, transceiver 28 may be capable of transmitting and receiving signals or data directly. Additionally or alternatively, in some example embodiments, apparatus 10 may include an input and/or output device (I/O device). In certain examples, apparatus 20 may further include a user interface, such as a graphical user interface or touchscreen.

In an example embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR. For instance, in an example embodiment, link 70 may represent the Xn interface.

According to some example embodiments, processor 22 and memory 24 may be included in or may form a part of processing circuitry or control circuitry. In addition, in some example embodiments, transceiver 28 may be included in or may form a part of transceiving circuitry.

As discussed above, according to example embodiments, apparatus 20 may be include an SDAP or RM at a UE or gNB. According to certain examples, apparatus 20 may be controlled by memory 24 and processor 22 to perform the functions associated with example embodiments described herein. For instance, in some example embodiments, apparatus 20 may be configured to perform one or more of the processes depicted in any of the diagrams or signaling flow diagrams described herein, such as those illustrated in FIG. 4b. In example embodiments, apparatus 20 may be configured to perform a procedure for improving the treatment of related or redundant data for a system.

In certain embodiments, apparatus 20 may be controlled by memory 24 and processor 22 to receive two or more flows (or streams) of packets and an indication that the flows of packets are related. In an embodiment, apparatus 20 may be controlled by memory 24 and processor 22 to receive an indication of the QoS constraints of the packets. For example, in one embodiment, apparatus 20 may be controlled by memory 24 and processor 22 to receive, from a replication management entity, direction to ensure that the latency, availability, and/or reliability requirements (e.g., based on the QoS constraints) of the flows of packets are fulfilled. According to some embodiments, apparatus 20 may be controlled by memory 24 and processor 22 to receive the redundant flows of packets with an added indication or header that indicates to treat the packets as uncorrelated. In an example embodiment, the packets may be manipulated to ensure that the packets are treated as uncorrelated. For example, the packets may be combined, excluded and/or further replicated in a manner that indicates to treat the packets as uncorrelated. In one example embodiment, apparatus 20 may be controlled by memory 24 and processor 22 to receive only a subset of the packets to the lower layer(s) and scaled QoS constraints to be fulfilled for the packets.

In some embodiments, apparatus 20 may also be controlled by memory 24 and processor 22 to utilize the indication of the related flows of packets for optimizing delivery of the flows of packets. According to certain embodiments, the optimizing of the delivery of the flows may include one or more of: ensuring time diversity in the transmission of the replicated packets (within time budget), utilizing frequency or antenna diversity including mapping the data to different component carriers, utilizing spatial diversity in multi-connectivity-capable systems (transmission/reception different cells/DUs), applying further duplication (e.g., PDCP layer duplication), and/or ensuring handovers of data carrying paths do not happen simultaneously.

According to certain embodiments, for example in systems with multi-UE capable receivers, the optimizing of the delivery of the flows may include one or more of: scheduling the related packets independently to each UE comprising the multi-UE receiver, connecting the UEs to different gNBs, and/or preventing simultaneous handovers on the different gNB-UE links.

In an example where apparatus 20 receives a single packet with scaled QoS constraints, apparatus 20 may be controlled by memory 24 and processor 22 to treat the packet in a normal manner at the SDAP layer. For example, the URLLC framework may be exploited to deliver the single packet with 99.9999+% reliability. This may include PDCP duplication, repetitions, or other techniques as decided by the communication system. In another example, apparatus 20 may be controlled by memory 24 and processor 22 to map each of the related flows of packets to separate DRBs in the SDAP layer, each DRB potentially using the URLLC framework (e.g., PDCP duplication) to increase the reliability of each path.

According to some embodiments, apparatus 20 may be further controlled by memory 24 and processor 22 to forward the flows of packets to one or more output ports for transmission to one or multiple destinations.

Therefore, certain example embodiments provide several technical improvements, enhancements, and/or advantages. For example, certain embodiments may effectively improve the performance of “outside” reliability-oriented protocols, for example, by ensuring uncorrelated treatment of the incoming data. In addition, certain embodiments can translate the external reliability requirements into internal 3GPP QoS requirements, which is may be relevant if the 3GPP system has better means to ensure the QoS of the data. As such, example embodiments can improve performance, latency, and/or throughput of networks and network nodes including, for example, access points, base stations/eNBs/gNBs, and mobile devices or UEs. Accordingly, the use of certain example embodiments results in improved functioning of communications networks and their nodes.

In some example embodiments, the functionality of any of the methods, processes, signaling diagrams, algorithms or flow charts described herein may be implemented by software and/or computer program code or portions of code stored in memory or other computer readable or tangible media, and executed by a processor.

In some example embodiments, an apparatus may be included or be associated with at least one software application, module, unit or entity configured as arithmetic operation(s), or as a program or portions of it (including an added or updated software routine), executed by at least one operation processor. Programs, also called program products or computer programs, including software routines, applets and macros, may be stored in any apparatus-readable data storage medium and include program instructions to perform particular tasks.

A computer program product may comprise one or more computer-executable components which, when the program is run, are configured to carry out some example embodiments. The one or more computer-executable components may be at least one software code or portions of it. Modifications and configurations required for implementing functionality of an example embodiment may be performed as routine(s), which may be implemented as added or updated software routine(s). Software routine(s) may be downloaded into the apparatus.

As an example, software or a computer program code or portions of it may be in a source code form, object code form, or in some intermediate form, and it may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality may be performed by hardware or circuitry included in an apparatus (e.g., apparatus 10 or apparatus 20), for example through the use of an application specific integrated circuit (ASIC), a programmable gate array (PGA), a field programmable gate array (FPGA), or any other combination of hardware and software. In yet another example embodiment, the functionality may be implemented as a signal, a non-tangible means that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, including at least a memory for providing storage capacity used for arithmetic operation and an operation processor for executing the arithmetic operation.

One having ordinary skill in the art will readily understand that the example embodiments as discussed above may be practiced with steps in a different order, and/or with hardware elements in configurations which are different than those which are disclosed. Therefore, although some embodiments have been described based upon these example preferred embodiments, it would be apparent to those of skill in the art that certain modifications, variations, and alternative constructions would be apparent, while remaining within the spirit and scope of example embodiments. In order to determine the metes and bounds of the example embodiments, therefore, reference should be made to the appended claims.

1. A method, comprising:
detecting, by a network entity, that two or more flows of data packets are related;
informing at least one lower layer that the detected flows of packets are related and informing the at least one lower layer of quality of service (QoS) constraints of the packets; and
directing the at least one lower layer to ensure that at least one of latency, availability, or reliability requirements of the flows of packets are fulfilled.

2. The method according to claim 1, wherein the related flows of packets comprise redundant packets.

3. The method according to claim 1, wherein the detecting comprises determining whether the flows of packets are used for redundant packets of internet protocol (IP)/Ethernet flows.

4. The method according to claim 1, wherein the detecting comprises at least one of:
associating related sub-flows of the packets with each other; and
inspecting at least one packet of the flows of packets or receiving information from an external system to detect that at least two sub-flows of the packets are transmitting related data.

5. The method according to claim 1, wherein the directing comprises forwarding the detected flows of packets to the at least one lower layer with an added indication or header that indicates to the at least one lower layer to treat the packets as uncorrelated.

6. The method according to claim 1, wherein the directing comprises manipulating the header or control information of the packets to ensure that the at least one lower layer treat the packets as uncorrelated.

7. The method according to claim 1, further comprising identifying the quality of service (QoS) constraints that need to be fulfilled for the packets.

8. The method according to claim 7, wherein the directing further comprises forwarding only a subset of the packets to the at least one lower layer and scaling the quality of service (QoS) constraints to be fulfilled by the at least one lower layer.

9. The method according to claim 1, wherein the network entity comprises a data packet replication manager attached to a user plane function.

10. An apparatus, comprising:
at least one processor; and
at least one memory comprising computer program code,
the at least one memory and computer program code configured, with the at least one processor, to cause the apparatus at least to
detect that two or more flows of packets are related;
inform at least one lower layer that the detected flows of packets are related and informing the at least one lower layer of quality of service (QoS) constraints of the packets; and
direct the at least one lower layer to ensure that at least one of latency, availability, or reliability requirements of the flows of packets are fulfilled.

11. The apparatus according to claim 10, wherein the related flows of packets comprise redundant packets.

12. The apparatus according to claim 10, wherein the at least one memory and computer program code are further configured, with the at least one processor, to cause the apparatus at least to determine whether the flows of packets are used for redundant packets of internet protocol (IP)/Ethernet flows.

13. The apparatus according to claim 10, wherein the at least one memory and computer program code are further configured, with the at least one processor, to cause the apparatus at least to:
associate related sub-flows of the packets with each other; and
inspect at least one packet of the flows of packets or receiving information from an external system to detect that at least two sub-flows of the packets are transmitting related data.

14. The apparatus according to claim 10, wherein the at least one memory and computer program code are further configured, with the at least one processor, to cause the apparatus at least to forward the detected flows of packets to the at least one lower layer with an added indication or header that indicates to the at least one lower layer to treat the packets as uncorrelated.

15. The apparatus according to claim 10, wherein the at least one memory and computer program code are further configured, with the at least one processor, to cause the apparatus at least to manipulate the header or control information of the packets to ensure that the at least one lower layer treat the packets as uncorrelated.

16. The apparatus according to claim 10, wherein the at least one memory and computer program code are further configured, with the at least one processor, to cause the apparatus at least to identify the quality of service (QoS) constraints that need to be fulfilled for the packets.

17. The apparatus according to claim 16, wherein the at least one memory and computer program code are further configured, with the at least one processor, to cause the apparatus at least to forward only a subset of the packets to the at least one lower layer and scaling the identified quality of service (QoS) constraints to be fulfilled by the at least one lower layer.

18. The apparatus according to claim 10, wherein the apparatus comprises a replication manager attached to a user plane function.

19.-29. (canceled)

30. An apparatus, comprising:
at least one processor; and
at least one memory comprising computer program code,
the at least one memory and computer program code configured, with the at least one processor, to cause the apparatus at least to
receive two or more flows of packets and an indication that the flows of packets are related;
receive an indication of quality of service (QoS) constraints of the packets; and
use the indication that the flows of packets are related for optimizing delivery of the flows of packets.

31. The apparatus according to claim 30, wherein the at least one memory and computer program code are further configured, with the at least one processor, to cause the apparatus at least to receive, from a replication management entity, direction to ensure that at least one of latency, availability, or reliability requirements of the flows of packets are fulfilled.

32. The apparatus according to claim 30, wherein the at least one memory and computer program code are further configured, with the at least one processor, to cause the apparatus at least to:
receive the related flows of packets with an added indication or header that indicates to treat the packets as uncorrelated, and
treat the packets as being uncorrelated.

33. The apparatus according to claim 30, wherein the optimizing of the delivery of the flows comprises at least one of:
ensuring time diversity in the transmission of the related packets;
utilizing frequency or antenna diversity including mapping the packets to different component carriers;
utilizing spatial diversity in multi-connectivity-capable systems;
applying further duplication; and
ensuring handovers of data carrying paths do not happen simultaneously.

34. The apparatus according to claim 30, wherein, in systems with multi user equipment capable receivers, the optimizing of the delivery of the flows comprises at least one of:
scheduling the related packets independently to each user equipment comprising the multi user equipment receiver;
connecting the user equipment to different next generation node Bs (gNBs); and
preventing simultaneous handovers on different gNB-user equipment links.

35. The apparatus according to claim 30, wherein the at least one memory and computer program code are further configured, with the at least one processor, to cause the apparatus at least to forward the flows of packets to one or more output ports for transmission to one or multiple destinations.

36. The apparatus according to claim 30, wherein the related flows of packets comprise redundant packets.

37. (canceled)

38. (canceled)
